(19) United States
(12) Patent Application Publication
(10) Pub. No.: US 2014/0354175 A1
(43) Pub. Date: Dec. 4, 2014

(54) HIGH WATT TYPE CERAMIC METAL HALIDE LAMP ILLUMINATION DEVICE

(71) Applicants: Masashi Iida, Gyoda City (JP); Akiyoshi Maehara, Gyoda City (JP); Makoto Ohkahara, Gyoda City (JP)

(72) Inventors: Masashi Iida, Gyoda City (JP); Akiyoshi Maehara, Gyoda City (JP); Makoto Ohkahara, Gyoda City (JP)

(73) Assignee: IWASAKI ELECTRIC CO., LTD., Tokyo (JP)

(21) Appl. No.: 14/344,723

(22) PCT Filed: Aug. 4, 2012
(86) PCT No.: PCT/JP2012/069921

§ 371 Date: Mar. 13, 2014

(30) Foreign Application Priority Data
Sep. 14, 2011 (JP) 2011-201204

(51) Int. Cl. H05B 41/24

(52) U.S. Cl. CPC H05B 41/24
USPC 315/291

(57) ABSTRACT

A high watt type ceramic metal halide lamp illumination device is provided. The device comprises: ballast receiving a primary input voltage and outputting a secondary voltage, and a lamp having a plurality of arc tubes electrically connected in series inside an outer bulb. The lamp is lighted by receiving the secondary voltage output from the ballast. The secondary voltage output from the ballast has a waveform that at least satisfies a maximum-value to effective-value ratio (Vmax/Veff) of greater than 2^{0.5}. When using two 360 W arc tubes of a popular type by electrically connecting the two in series instead of a 700 W arc tube of a high-watt type, for example, it is preferable to use a triangular waveform AC voltage that satisfies 260≦Veff_{(triangular waveform)} when expressed by the effective-value, and 500 V≦Vmax_{(triangular waveform)} when expressed by the maximum-value.

### TECHNICAL FIELD

The present invention relates to a high watt type ceramic metal halide lamp illumination device. More specifically, the present invention relates to a high watt type ceramic metal halide lamp illumination device in which a plurality of arc tubes (for example, two arc tubes) are connected in series.

### BACKGROUND ART

Recently, it is frequently observed that a high watt type ceramic metal halide lamp is utilized as the lighting for use with sports facilities and stadiums in such a fashion that the lamp is installed in the horizontal direction (lamp is horizontally lighted). Since a large-size arc tube for use with such high watt type lamp is long in arc length, it is feared that arc will be moved away from a central axis of the lamp, curved and floated to thereby heat a discharge ceramic vessel of the arc tube, thus resulting in the ceramic vessel being cracked.

Also, it is necessary that a conducting material sealed into the ceramic discharge vessel of a high watt type ceramic metal halide lamp should be increased in diameter. If the conducting material is large in diameter, then when the conducting material is expanded by the heat generated from the lamp during the lamp is being lighted, there is some fear that the ceramic discharge vessel will be cracked by a difference between coefficients of thermal expansion of the ceramic discharge vessel and the conducting material.

Further, a relatively large-size arc tube needs a large ceramic vessel and the manufacture of such large ceramic vessel is relatively difficult. Thus, such large arc tube has a drawback that the manufacturing cost thereof will be increased inevitably.

### CITATION LIST

### Patent Literature

Patent Literature 1: Japanese Patent Publication No. 61-227361 “HIGH-PRESSURE DISCHARGE LAMP” (Publication Date: Oct. 9, 1986). The Patent Literature 1 has mentioned a high-pressure sodium vapor discharge lamp which includes two arc tubes made of aluminum oxide connected in series inside an outer bulb.

### SUMMARY OF INVENTION

### Technical Problem

Having followed the Patent Literature 1, the inventors of the present application hits on an idea in which a 700 W arc tube, for example, may be replaced with two 360 W popular arc tubes electrically connected in series. This idea will be able to solve the problems such as the arc being floated from the central axis and the problem of expensive manufacturing cost.

However, when the inventors of the present application had experimentally produced a ceramic metal halide lamp in which such two popular ceramic arc tubes are electrically connected in series and had energized this lamp to light by the use of a conventional ballast, such a new problem became clear that the lamp cannot be shifted from a glow discharge mode to an arc discharge mode and the temperature of the lamp is raised while it is staying in the glow discharge mode. As a result the lamp was turned off.

Accordingly, it is an object of the present invention to provide a high watt type ceramic metal halide lamp illumination device in which a plurality of arc tubes (for example, two arc tubes) are connected in series and they are capable of stably turning on.

### Solution to Problem

A high watt type ceramic metal halide lamp illumination device of the present invention comprises ballast for receiving a primary input voltage and outputting a secondary voltage; and a lamp having a plurality of arc tubes electrically connected in series inside an outer bulb and being lighted by receiving the secondary output voltage from said ballast, wherein the secondary output voltage from said ballast has a waveform that at least satisfies a maximum-value to effective-value ratio (Vmax/Veff) of greater than 2^{0.5}.

Further, in the above ceramic metal halide lamp illumination device, the secondary output voltage from said ballast may have a waveform that at least satisfies a maximum-value to effective-value ratio (Vmax/Veff) of greater than 3^{0.5}.

Further, in the above ceramic metal halide lamp illumination device, further, the secondary output voltage from said ballast may have a waveform that satisfies the conditions that (a) an effective-value is greater than the total sum of electric glow discharge sustaining voltages of respective arc tubes and that (b) a maximum-value is greater than the total sum of arc discharge transition voltages of respective arc tubes.

Further, in the above ceramic metal halide lamp illumination device, the secondary output voltage from said ballast may have a waveform that satisfies the conditions that (a) an effective-value is greater than the total sum of glow discharge sustaining voltages of respective arc tubes and is less than the total sum of arc discharge transition voltages of respective arc tubes and that (b) a maximum-value is greater than the total sum of arc discharge transition voltages of respective arc tubes and is less than the total sum of breakdown voltages of respective arc tubes.

Further, in the above ceramic metal halide lamp illumination device, the secondary output voltage from said ballast may be a triangular waveform AC voltage.

Further, in the above ceramic metal halide lamp illumination device, if two popular type 360 W arc tubes are electrically connected in series as said plurality of arc tubes instead of a high watt type 700 W arc tube, said triangular waveform AC voltage may satisfy 500 V≦Vmax_{(triangular waveform)} when expressed by the maximum-value and 260 V≦Veff_{(triangular waveform)} when expressed by the effective-value.

Further, in the above ceramic metal halide lamp illumination device, if two popular type 360 W arc tubes are electrically connected in series as said plurality of arc tubes instead of a high watt type 700 W arc tube, said triangular waveform AC voltage may satisfy 500 V≦Vmax_{(triangular waveform)} when expressed by the maximum-value and 260 V≦Veff_{(triangular waveform)}≦500 V when expressed by the effective-value.

### Advantageous Effects of Invention

According to the present invention, it is possible to provide a high watt type ceramic metal halide lamp illumination device in which a plurality of arc tubes (for example, two arc tubes) are connected in series and they are capable of stably turning on.

### BRIEF DESCRIPTION OF DRAWINGS

FIG. 1 is a diagram useful for briefly explaining a discharge phenomenon occurred within a HID lamp.

FIG. 2 is a cross-sectional view showing the main part of a ceramic metal halide lamp along a central axis of the lamp, according to an example of the present invention.

FIG. 3 is a cross-sectional view showing the main part of an arc tube along the central axis of the arc tube, for use with the lamp shown in FIG. 2.

FIG. 4 is a table showing characteristics of the arc tube of FIG. 3.

FIG. 5 is a schematic diagram showing a circuit of a ceramic metal halide lamp illumination device.

FIG. 6 is a diagram showing a variety of voltage waveforms which have been studied for secondary voltages from a ballast, wherein FIG. 6A shows a rectangular voltage waveform, FIG. 6B shows a sine voltage waveform and FIG. 6C shows a triangular voltage waveform.

FIG. 7 is a diagram showing characteristics of effective-value to maximum-value of a secondary voltage from a ballast by using the respective voltages waveforms shown in FIG. 6 as parameters and in which open circles “0” indicate experimental data in which the lamp could be shifted to the arc discharge mode and cross marks “X” indicate experimental data in which the lamp could not be shifted to the arc discharge mode.

FIG. 8 is a diagram showing other example of a waveform of a secondary voltage from a ballast.

### DESCRIPTION OF EMBODIMENTS

A high watt type ceramic metal halide lamp illumination device according to the examples of the present invention will hereinafter be described in detail with reference to the accompanying drawings. An identical element is assigned with an identical reference numeral in the drawings and need not be explained one more time. It should be noted that the examples of the present invention are showed only as the examples in order to explain the present invention and that those examples may not limit the technical scope of the present invention at all.

[Discharge Phenomena within HID Lamp]

In order to facilitate the understanding of the present invention, at first, discharge phenomena occurred within an arc tube of a HID lamp (High Intensity Discharge lamp) will be described in brief. The HID lamp is a general term of lamps such as a mercury lamp, a metal halide lamp and a high-pressure sodium lamp. Of metal halide lamps, lamps including arc tubes made of ceramics are generally referred to as ceramic metal halide lamps.

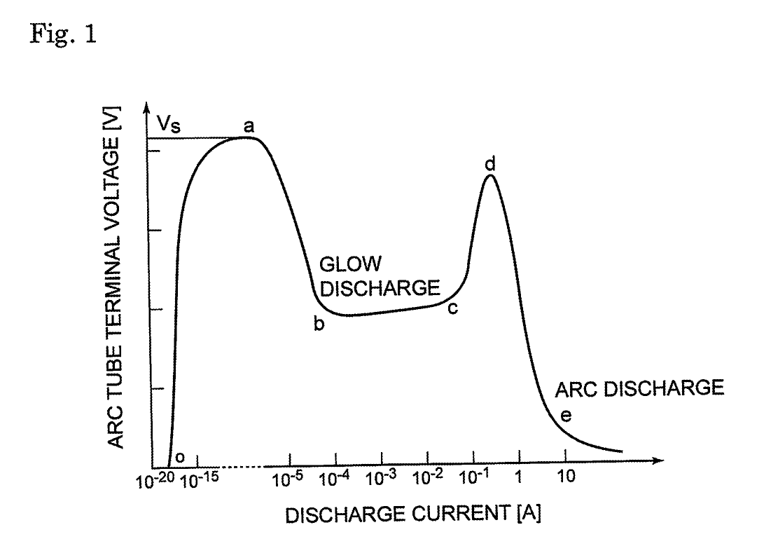

When an alternating current voltage applied to the electrodes of the arc tube for use with the HID lamp is gradually increased and exceeds a certain limit, there occurs a discharge phenomenon in which strong light is observed between the electrodes. FIG. 1 is a diagram to which reference will be made in briefly explaining discharge phenomena occurred within the arc tube. Current-voltage characteristics of discharge will be explained in which a vertical axis represents an arc tube terminal voltage V and a horizontal axis represents a discharge current A corresponding to the arc tube terminal voltage. The reason that the arc tube terminal voltage V is not represented by specific numerical values on the vertical axis is that numerical values of the arc tube terminal voltage may change depending upon rated power of the arc tube, a size thereof, a distance between the electrodes thereof, the kind of gases sealed thereinto, the pressures therein and so on.

When the arc tube terminal voltage is increased gradually, an area shifting from the point (o) to the point (a) indicates a dark discharge area in which the lamp does not produce light at all prior to the initiation of discharge.

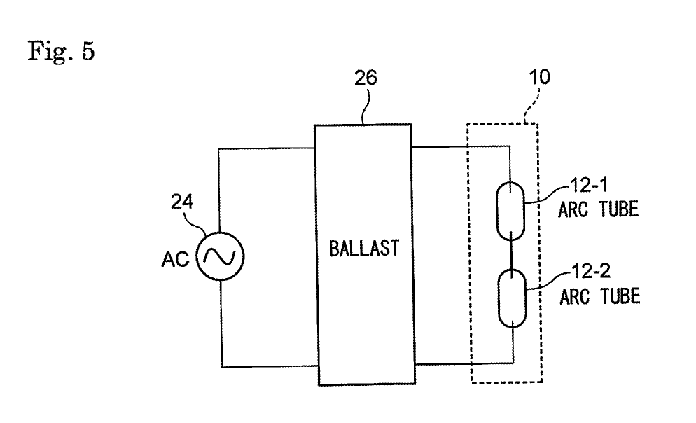

The operation to exceed the point (a) is referred to as a breakdown. The lamp carries out the breakdown by instantaneously superimposing a very high pulse voltage (for example, 3.7 to 4.5 kV) upon a base voltage (for example, 200 to 300 V) from a ballast (see FIG. 5). The application of this high-voltage pulse voltage is terminated immediately after the breakdown.

An area shifting from the point (b) to the point (c) indicates a glow discharge area in which a voltage is relatively high while a current is relatively small. Only emission of secondary electrons from a cathode electrode is regarded as a discharging current.

An area following the point (e) indicates an arc discharge area in which a voltage is comparatively low while a current is relatively large. An arc discharge sustaining voltage is a low voltage as compared with a glow discharge sustaining voltage. In the arc discharge area, either cold electron emission or hot electron emission of the cathode electrode is regarded as a discharge current. The HID lamp is a lamp that effectively utilizes the arc discharge in the high pressure vapor of metal electron within the arc tube.

In order for the lamp to be shifted from the glow discharge mode to the arc discharge mode, it needs an electrode voltage which exceeds a peak point (d) (this electrode voltage will be referred to as an “arc discharge transition voltage” in this application document). Accordingly, a trouble in which the lamp could not be shifted from the glow discharge mode to the arc discharge mode as described above is caused by such a reason that a voltage which exceeds the arc discharge transition voltage is not applied to the electrodes.

Moreover, this trouble does not occur in the high-pressure sodium vapor discharge lamp disclosed in the Patent Literature 1. The reason for this is that, since emissive materials are coated on the electrodes of the high-pressure mercury lamp and the high-pressure sodium lamp, the glow discharge voltage thereof is relatively low as compared with that of the ceramic metal halide lamp and the arc discharge transition voltage is relatively low accordingly. Further, the arc tubes for use with the high-pressure mercury lamp and the high-pressure sodium lamp are made of quartz. As compared with the ceramic arc tube, the quartz arc tube can easily react with metal halides sealed into the arc tube but at the same time the quartz arc tube is strong against thermal shock.

### First Example

### High Watt Type Ceramic Metal Halide Lamp

The high watt type ceramic metal halide lamp according to a first example is an example of a high watt type ceramic metal halide lamp which uses two popular arc tubes.

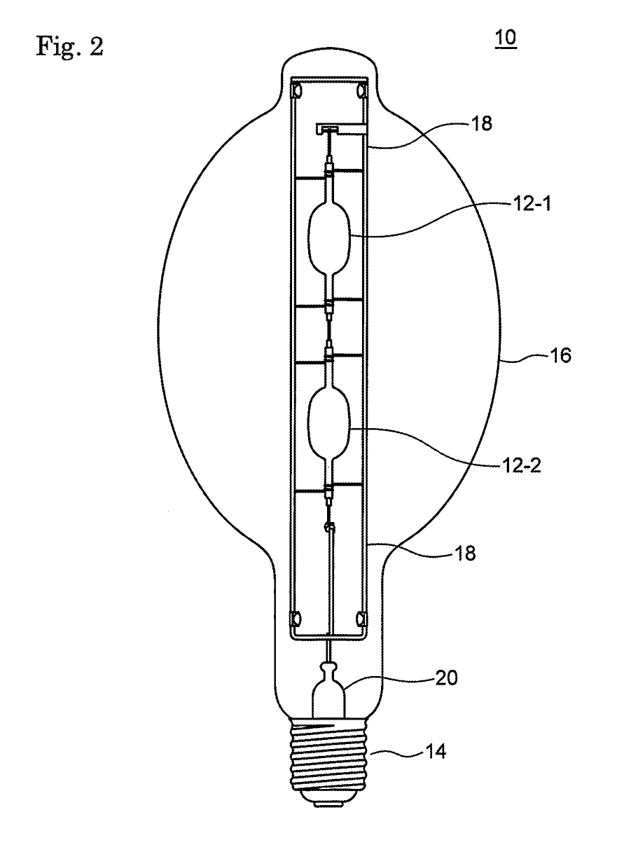

FIG. 2 is a cross-sectional view showing the main part of a high watt type (for example, 700 to 1,000 W) ceramic metal halide lamp 10 along a central axis of the lamp. The metal halide lamp 10 includes two arc tubes 12-1, 12-2 electrically connected in series which are secured to a support 18 inside the outer bulb equipped with a base. The support 18 is fixed to a stem 20. The inside of the outer bulb 16 is kept evacuated. Although not shown in FIG. 2, inside the outer bulb 16, there is provided a starting circuit (igniter) which instantly superimposes a high-pressure pulse voltage to lead to a breakdown upon an AC voltage outputted from a ballast (see FIG. 5).

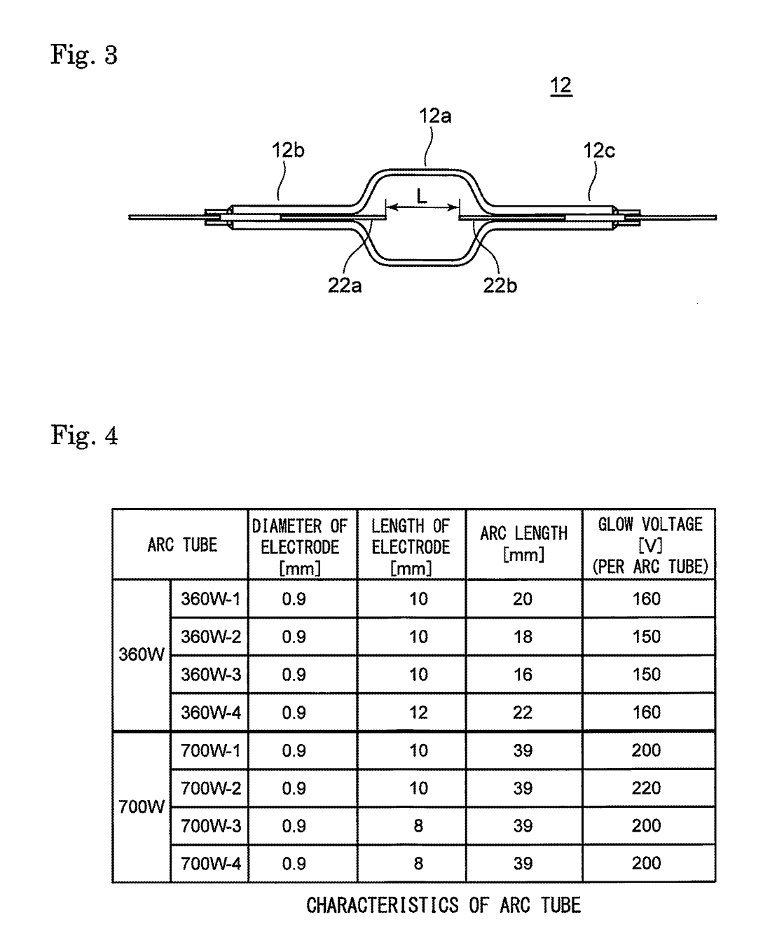

FIG. 3 is a cross-sectional view showing the main part of the arc tubes 12-1, 12-2 for use with the lamp shown in FIG. 2, along the central axis of the arc tube. Each of the arc tubes 12-1, 12-2 is made by integrally forming a light-emitting portion 12a of which cross-section is nearly elliptic and capillary portions 12b, 12c joined to both ends of the light-emitting portion so as to become a unitary body. The light-emitting portion 12a is made of ceramics and it is gradually decreased in inner diameter from the central portion to the capillary joint portion. Electrodes 22a, 22b are respectively inserted into the capillary portions 12b, 12c, respectively. A gap between the two electrodes corresponds to an arc length L.

As described above, since the arc tube becomes large in size as it becomes a high watt type (for example, 700 W arc tube and 1,000 W arc tube), the arc length is extended so that arc is floated from the central axis to thereby heat the ceramic vessel, causing the ceramic vessel to be cracked. Moreover, the manufacture of a large-size ceramic vessel is comparatively difficult and therefore a manufacturing cost becomes high unavoidably. Whereas a 360 W arc tube may be available at present as arc tubes mass-produced and widely used comparatively, as a result of which it can be obtained relatively inexpensively on the market. A 270 W arc tube, a 440 W and the like arc tube are also available as such inexpensive arc tubes. The lamp shown in FIG. 2 uses such a popular arc tube.

FIG. 4 is a table showing characteristics of the arc tube shown in FIG. 3. On this table, there are shown four kinds of data of arc tubes “360 W-1 to 360 W-4” as data of 360 W popular arc tubes. Arc lengths L of these arc tubes fall within a range of 16 to 22 mm. Data which will be explained hereinafter are data obtained when the experiments were made by using the arc tube “360 W-4”.

There are also attached four kinds of data “700 W-1 to 700 W-4” as data of high watt type 700 W arc tubes on the above table, in order to compare data of popular arc tubes with each other. Arc lengths L of these high watt type arc tubes are 39 mm which is a relatively long arc length. Since the arc lengths L of these arc tubes are long, when this arc tube is horizontally lighted, arc is floated and considerably curved from the central axis of the arc tube by convection of a gas enclosed within the arc tube.

FIG. 5 is a schematic diagram of a circuit for use with a ceramic metal halide lamp illumination device. A power supply 24 is a commercially-available AC power supply of 200 V (in some special case, 100 V). A ballast 26 outputs a predetermined ballast secondary voltage by using a transformer and a choke coil.

The inventors of the present application has concluded that the following conditions should be satisfied in order for the two arc tubes connected in series to smoothly be shifted from the glow discharge mode to the arc discharge mode. Referring to FIG. 1, the above conditions are such that (a) a steady-state value of a terminal voltage applied to both ends of the two arc tubes 12-1, 12-2 should be greater than the total sum of glow discharge sustaining voltages (see points “b” to “c”) of the respective arc tubes and that (b) an instantaneous value of the above terminal voltage should be greater than the total sum of arc discharge transition voltages (see point “d”) of the respective arc tubes.

If electric characteristics of the two arc tubes 12-1, 12-2 are exactly the same, then the secondary output voltage from the ballast 26 is applied to the respective arc tubes 12-1, 12-2 as the terminal voltages by ½ each. As a matter of fact, electric characteristics of the respective arc tubes are not always the same. However, if the steady-state values of the terminal voltages are greater than the total sum of the glow discharge sustaining voltages of the respective arc tubes, then the arc tubes can maintain the glow discharge mode. Similarly, if the instantaneous values of the terminal voltages are greater than the total sum of the arc discharge transition voltages of the respective arc tubes, then one arc tube is always shifted to the arc discharge mode. The arc tube that was shifted to the arc discharge mode indicates a negative resistance and the terminal voltage applied to this arc tube is lowered rapidly with the result that a larger voltage is further applied to the other arc tube, whereby the other arc tube also is shifted to the arc discharge mode.

For this reason, the inventors of the present application has investigated a secondary output voltage from the ballast of which (a) effective-value is greater than the total sum of the glow discharge sustaining voltages of the respective arc tubes and of which (b) maximum-value is greater than the total sum of arc discharge transition voltages of the respective arc tubes.

As a result, the inventors of the present application have concluded that the above conditions may be satisfied by varying a waveform of a secondary output voltage from a ballast. Namely, a waveform of a secondary output voltage from a conventional ballast is a sine waveform. The above-described conditions can be satisfied by replacing this sine waveform with a triangular waveform, for example. For the sake of explanation, advantages of the triangular waveform will be described together with an example of a square waveform in addition to the example of the conventional sine waveform.

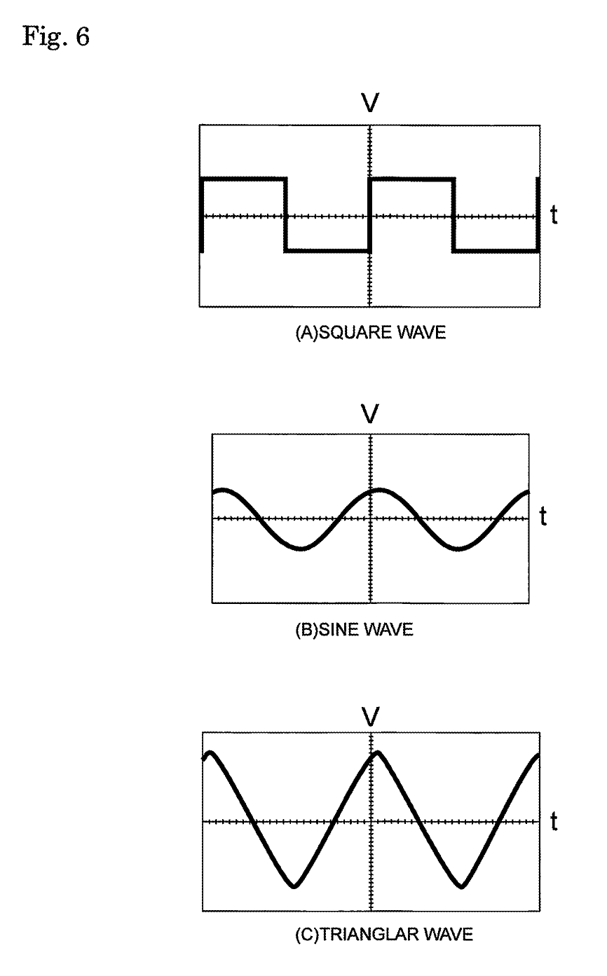

FIG. 6 is a diagram showing various kinds of voltage waveforms which have been examined as the secondary output voltage from the ballast. FIG. 6A shows a voltage waveform of a square wave, FIG. 6B shows a voltage waveform of a sine wave and FIG. 6C shows a voltage waveform of a triangular wave. In the case of the triangular wave, the waveform of the triangular wave may have variations. If the waveform of the triangular wave is an equilateral triangle, then the ratio of a height “h” to a base “a” of the waveform is given by h/a=3^{0.5}. If a time axis of the waveform of an equilateral triangle and a time axis of a waveform of an isosceles triangle are matched by the use of an oscilloscope, then the above ratio of the height to the base of the waveform of an isosceles triangle is given by h/a>3^{0.5} if the height “h” is comparatively long as compared with that of the equilateral triangle. If the height “h” is comparatively short as compared with that of the equilateral triangle is given by h/a≦3^{0.5}. It should be noted that the term “triangular waveform” may contain the waveform of the equilateral triangle and such variation of the triangular waveform in the document of the present application.

With respect to a square wave voltage, a relationship between the effective-value and the maximum-value is expressed as Vmax_{(square waveform)}=Veff_{(square waveform)}. With respect to a sine wave voltage, a relationship between the effective-value and the maximum value is expressed as Vmax_{(sine waveform)}=2^{0.5}Veff_{(sine waveform)}=1.414 Veff_{(sine waveform)}. On the other hand, with respect to the triangular wave voltage that had been carried out the experiment this time, a relationship between the effective-value and the maximum-value was given by Vmax_{(triangular waveform)}=1.941·Veff_{(triangular waveform)}.

In the case of the same effective-value Veff (for example, 280 V), the maximum-value is the same as the effective-value in case of the square waveform and hence Vmax_{(square waveform)}=Veff_{(square waveform)}=280 V is satisfied. The maximum-value is 1.414 times as large as the effective-value in case of the sine waveform and hence Vmax_{(sine waveform)}=1.414·Veff_{(sine waveform)}=396 V is satisfied. On the other hand, the maximum-value is 1.941 times as large as the effective-value in case of the triangular waveform and hence Vmax_{(triangular waveform)}=1.914·Veff_{(triangular waveform)}=543 V is satisfied. Thus, the maximum-value can be increased even if the effective-value is same and hence it is possible to easily obtain a relatively high arc discharge transition voltage.

A study of this result revealed that a waveform with a ratio larger than the maximum-value to effective-value ratio (Vmax_{(sine waveform)}/Veff_{(sine waveform)}=2^{0.5}) of the sine waveform that has been conventionally used should be required. The waveform of this ratio can satisfy the third condition, (c) the waveform should satisfy maximum-value to effective-value ratio (Vmax/Veff)>2^{0.5}. As a typical example of such waveform, there is known a triangular waveform of which the maximum-value to effective-value ratio (Vmax/Veff) of the secondary output voltage is large.

Further, in order to realize a small and low output ballast, as is clear from FIG. 1, the maximum-value Vmax of the secondary output voltage may be lower than the breakdown voltage (point “a” in FIG. 1) (namely, Vmax<total sum of breakdown voltages of respective arc tubes is satisfied). Also, the effective-value Veff of the secondary output voltage may be lower than the arc discharge transition voltage (point “d” in FIG. 1) (namely, Veff<total sum of arc discharge transition voltages of respective arc tubes is satisfied).

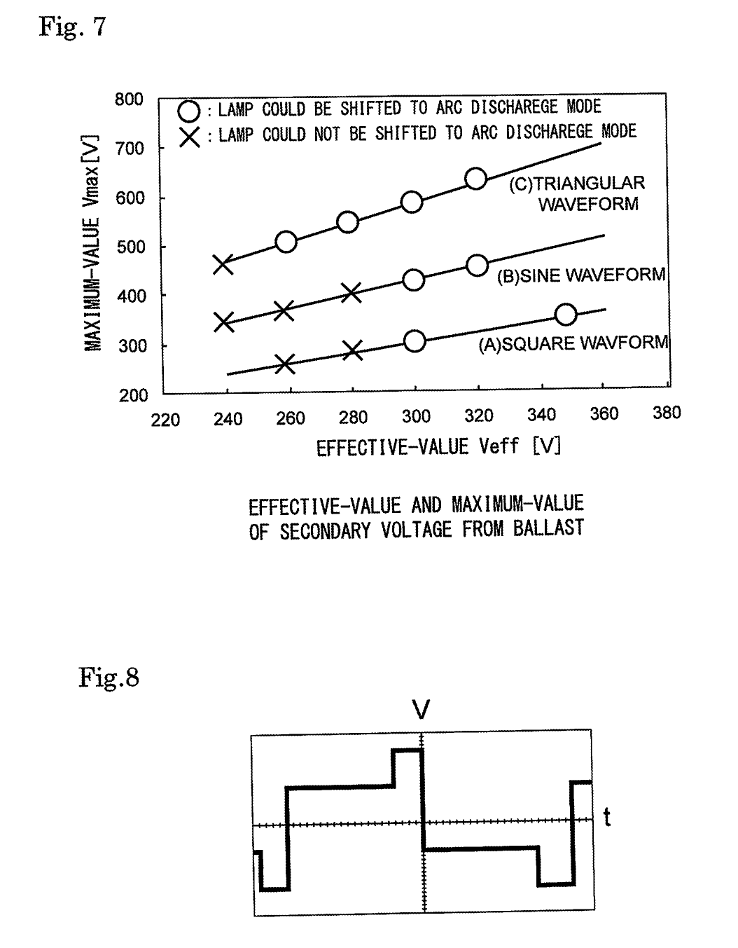

FIG. 7 is a diagram showing effective-value to maximum-value characteristics of secondary voltages from the ballast by using the respective waveforms of the voltages shown in FIG. 6 as parameters. This characteristic diagram shows the results obtained when the experiments were carried out in order to check whether or not two arc tubes of “360 W arc tube-4” could be shifted to the arc discharge mode. Open circles “◯” show experimental data which indicate that the arc tubes can be shifted to the arc discharge mode. Cross marks “X” show experimental data which indicate that the arc tubes could not be shifted to the arc discharge mode.

As shown in FIG. 7, it was confirmed that the arc tube could be shifted to the arc discharge mode at the effective-value Veff_{(triangular waveform)}=260 V, 280 V, 300 V, 320 V, . . . of the secondary output voltage of the triangular waveform. On the other hand, it was confirmed that the arc tube could be shifted to the arc discharge mode at the effective-value Veff_{(sine waveform)}≧300 V of the secondary output voltage of the sine waveform. With respect to the square waveform, it was similarly confirmed that the arc tube could be shifted to the arc discharge mode at the effective-value Veff_{(square waveform)}≧300 V. If a waveform of a secondary output voltage is a triangular waveform, then a higher maximum-value can be obtained even at the same effective-value as compared with other waveforms and hence the arc tube can be shifted to the arc discharge mode. This means that the arc tube can use a relatively small and inexpensive ballast.

According to “Technical Standard about the Electric equipment” of regulations of Japan, a required insulation resistance between electric wires of electrical circuits using a low voltage and a required insulation resistance between an electrical circuit and the ground may fluctuate depending upon a secondary output voltage under or over 300 V. If a required insulation resistance becomes high, then a manufacturing cost of a ballast is increased, which is not preferable. Accordingly, in Japan, when using two 360 W arc tubes of popular type by electrically connecting in series instead of a 700 W arc tube, it is possible to use a triangular waveform voltage that satisfies 260 V≦Veff_{(triangular waveform)}≦300 V when expressed by the effective-value. However, these are the restrictions concerning the regulations but they are not the restrictions concerning the technical contents of the invention.

This embodiment of the present invention has been described so far on the assumption that the waveform of the secondary output voltage from the ballast is the triangular waveform. However, it should be noted that the waveform of the secondary output voltage is not limited to the triangular waveform. The required conditions of the secondary output voltage from the ballast are (a) the effective-value should be greater than the total sum of the glow discharge sustaining voltages of the respective arc tubes, (b) the maximum-value should be greater than the total sum of the arc discharge transition voltages of the respective arc tubes and (c) the waveform of the secondary output voltage should satisfy the maximum-value to effective-value ratio (Vmax/Veff)>2^{0.5}. FIG. 8 shows other example of a waveform of a secondary output voltage from a ballast. A secondary output voltage composed of two kinds of square waveforms superimposed upon one another as shown in FIG. 8, for example, can satisfy the above-described conditions.

### Second Example

Although not shown, a second example describes an example in which three arc tubes or more are electrically connected in series. An arc tube of a high watt type, for example 1000 W arc tube, can be replaced with three 360 W popular arc tubes. A secondary output voltage from a ballast can satisfy the conditions (a) the effective-value should be greater than the total sum of the glow discharge sustaining voltages of the respective arc tubes, (b) the maximum-value should be greater than the total sum of the arc discharge transition voltages of the respective arc tubes and (c) the waveform should satisfy the maximum-value to effective-value ratio (Vmax/Veff)>2^{0.5}.

In this case, this example has merits by which popular arc tubes can be used. At the same time, this example has demerits such that, since the total sum of the glow discharge sustaining voltages and the total sum of the arc discharge transition voltages of three 360 W arc tubes, for example, become larger than the glow discharge sustaining voltage and the arc discharge transition voltage of a 1000 W arc tube, respectively, it becomes necessary to prepare a ballast which can generate a secondary output voltage corresponding to the above glow discharge sustaining voltages and the above glow discharge transition voltages.

### Third Example

Although not shown, a third example describes an example in which a plurality of arc tubes of different kinds is electrically connected in series. At present, 270 W arc tubes, 360 W arc tubes, 440 W arc tubes and so on are available as popular arc tubes. For example, a 1000 W lamp of high watt type can be realized by connecting (270 W arc tube+360 W arc tube+440 W arc tube) in series. Merits and demerits of this case are similar to those that had been described in the second example.

### ADVANTAGES AND EFFECTS OF EMBODIMENTS

As described above, the following advantages and effects of the embodiments of the present invention became clear.

(1) An arc tube of a high watt type metal halide lamp can be replaced with a plurality of popular arc tubes.

(2) In this case, as a plurality of popular arc tubes, there can be used two arc tubes or more.

(3) In this case, as a plurality of popular arc tubes, there can be used a combination of different output arc tubes (for example, 270 W arc tube, 360 W arc tube, 440 W arc tube, etc.).

(4) In this case, if a secondary output voltage from a ballast satisfies the conditions of (a) the effective-value is greater than the total sum of glow discharge sustaining voltages of respective arc tube, (b) the maximum-value is greater than the total sum of arc discharge transition voltages of respective arc tubes and (c) the waveform satisfies the maximum-value to effective-value ratio (Vmax/Veff)>2^{0.5}, then the lamp can be lighted smoothly.

(5) It is preferable that a voltage of a triangular waveform should be selected as a secondary output voltage from a ballast. The reason for this is that a minimum voltage for maintaining glow discharge and an arc discharge transition voltage can be obtained with ease.

(6) If two 360 W arc tubes of popular type are electrically connected in series instead of a 700 W arc tube as a high watt type ceramic metal halide lamp, then an AC voltage of a triangular waveform used in the experiments satisfies 260 V≦Veff_{(triangular waveform)} when expressed by the effective-value and satisfies 500 V≦Vmax_{(triangular waveform)} when expressed by the maximum-value.

### OTHERS

While the examples of the high watt type ceramic metal halide lamp according to the present invention have been described so far, these examples are given as only examples and may not limit the scope of the present invention at all. Addition, elimination, alteration, improvement and so on easily made on the examples of the present invention by those skilled in the art may fall within the scope of the present invention. A technical scope of the present invention should be determined based on the description of the attached claims.

### REFERENCE SIGNS LIST

10: ceramic metal halide lamp, 12, 12-1, 12-2: arc tube, 12a: light-emitting portion, 12b, 12c: capillary portion, 16: outer bulb, 14: base, 18: support, 20: stem, 22a, 22b: electrode, 24: commercially-available AC power supply, 26: ballast,
a: breakdown voltage, b to c: glow discharge area, d: arc discharge transition voltage, e: arc discharge area

1. A high watt type ceramic metal halide lamp illumination device comprising:
a ballast for receiving a primary input voltage and outputting a secondary voltage; and
a lamp being lighted by receiving the secondary output voltage from said ballast,
wherein said lamp has a plurality of relatively low output arc tubes electrically connected in series inside an outer bulb and being lighted simultaneously, instead of a high watt type arc tube,
the secondary output voltage from said ballast is that
(a) an effective-value Veff is greater than the total sum of glow discharge sustaining voltages of said relatively low output arc tubes,
(b) a maximum-value Vmax is greater than the total sum of arc discharge transition voltages of said relatively low output arc tubes, and
(c) a waveform thereof has a maximum-value Vmax and effective-value Veff which are decided on the basis of a ratio of arc discharge transition voltages and glow discharge sustaining voltages of said relatively low output arc tubes, said ratio satisfying a maximum-value to effective-value ratio (Vmax/Veff)≧3^{0.5}.

2. In a high watt type ceramic metal halide lamp illumination device according to claim 1, further
the secondary output voltage from said ballast is that
(a) the effective-value Veff is less than the total sum of arc discharge transition voltages of the respective arc tubes, and that
(b) the maximum-value Vmax is less than the total sum of breakdown voltages of the respective arc tubes.

3. In a high watt type ceramic metal halide lamp illumination device according to claim 1, wherein said relatively low output arc tubes are selected from among 270 W to 440 W arc tubes, respectively.

4. In a high watt type ceramic metal halide lamp illumination device according to claim 1,
the secondary output voltage from said ballast is a triangular waveform AC voltage.

5. In a high watt type ceramic metal halide lamp illumination device according to claim 4,
if two 360 W arc tubes are electrically connected in series as said plurality of low output arc tubes instead of a high watt type 700 W arc tube,
said triangular waveform AC voltage satisfies 500 V≦Vmax_{(triangular waveform)} when expressed by the maximum-value Vmax and 260 V≦Veff_{(triangular waveform)} when expressed by the effective-value Veff.

6. In a high watt type ceramic metal halide lamp illumination device according to claim 5,
said triangular waveform AC voltage satisfies 260 V≦Veff_{(triangular waveform)}≦300 V when expressed by the effective-value Veff.

7. (canceled)

8. In a high watt type ceramic metal halide lamp illumination device according to claim 2,
wherein said relatively low output arc tubes are selected from among 270 W to 440 W arc tubes, respectively.

9. In a high watt type ceramic metal halide lamp illumination device according to claim 2,
the secondary output voltage from said ballast is a triangular waveform AC voltage.

10. In a high watt type ceramic metal halide lamp illumination device according to claim 3,
the secondary output voltage from said ballast is a triangular waveform AC voltage.
